(19) United States
(12) Patent Application Publication
(10) Pub. No.: US 2026/0166515 A1
(43) Pub. Date: Jun. 18, 2026

(54) APPARATUS AND METHOD FOR HONEYCOMB CERAMIC-BASED PLASMA DEGRADATION OF SF6

(71) Applicants: Hubei University Of Technology (hbut), Wuhan (CN); CSG Electric Power Research Institute Co., Ltd., Guangzhou (CN)

(72) Inventors: Yalong LI, Wuhan (CN); Xiaoxing ZHANG, Wuhan (CN); Mingli FU, Wuhan (CN); Zhe HUANG, Wuhan (CN); Yangjing LE, Wuhan (CN); Zhaodi YANG, Wuhan (CN); Chao GAO, Wuhan (CN); Yan LUO, Wuhan (CN); Shuangshuang TIAN, Wuhan (CN); Guozhi ZHANG, Wuhan (CN); Yunjian WU, Wuhan (CN); Yin ZHANG, Wuhan (CN); Shuo JIN, Wuhan (CN); Fanchao YE, Wuhan (CN)

(73) Assignees: Hubei University Of Technology (hbut), Wuhan (CN); CSG Electric Power Research Institute Co., Ltd., Guangzhou (CN)

(21) Appl. No.: 19/365,163

(22) Filed: Oct. 21, 2025

(30) Foreign Application Priority Data
Dec. 12, 2024 (CN) 2024118297571

(51) Int. Cl. B01J 19/08; B01J 23/72; B01J 37/12; C01B 7/20; C01B 17/04

(52) U.S. Cl. CPC B01J 19/088; B01J 23/72; B01J 37/12; C01B 7/20; C01B 17/0434; B01J 2219/00162; B01J 2219/0898

(57) ABSTRACT

Disclosed is an apparatus for honeycomb ceramic-based plasma degradation of SF₆ in the technical field of sulfur hexafluoride degradation, including a DBD reactor, where a gas supply unit is arranged on a left side of the DBD reactor, a power supply unit is arranged at a bottom of the DBD reactor, a treatment unit is arranged on a right side of the DBD reactor, and the DBD reactor is connected to the gas supply unit via a gas pipe and electrically connected to the power supply unit. The apparatus breaks away from the conventional single-tube structured inner electrode by adopting a novel detachable honeycomb ceramic structure as the inner electrode of the reactor; its porous structure provides good channels for gas flow and distribution; the porous channels facilitate the adsorption of catalysts and decomposition products, effectively promoting the degradation process.

### CROSS-REFERENCE TO RELATED APPLICATIONS

The application claims priority to Chinese patent application No. 2024118297571, filed on Dec. 12, 2024, the entire contents of which are incorporated herein by reference.

### TECHNICAL FIELD

This disclosure relates to the technical field of degradation of sulfur hexafluoride and, in particular, to an apparatus and method for honeycomb ceramic-based plasma degradation of SF₆.

### BACKGROUND

Sulfur hexafluoride (SF₆) has excellent insulation and arc-quenching properties and is widely used in electrical equipment such as gas-insulated circuit breakers, transmission pipelines, insulated substations, and transformers. Due to its high global warming potential (GWP), SF₆ is listed as one of the six greenhouse gases subject to restricted emissions. It is highly stable in the atmosphere, has a long lifecycle, and is difficult to degrade naturally. With the rapid development of the power industry, the usage of SF₆ is increasing annually. However, SF₆ leakage occurs every year in power systems due to equipment maintenance, replacement, and other circumstances. Direct emission of SF₆ waste gas can cause a significant environmental impact. Currently, the primary emission reduction methods include replacing SF₆ gas with environmentally friendly gases (low GWP gases), recycling and reusing SF₆, and SF₆ waste gas degradation treatment technology. Among these methods, the SF₆ degradation treatment technology offers advantages such as high degradation efficiency and low energy consumption. SF₆ degradation treatment methods are further divided into pyrolysis, photocatalysis, and plasma methods, where the plasma method utilizes effective active species such as energetic electrons, ions, and free radicals in the plasma to react with SF₆ molecules, enabling their dissociation within a short time. The dielectric barrier discharge (DBD) plasma method offers advantages such as a high degradation rate, relatively high energy efficiency, reliable discharge, and a simple apparatus, and is widely used for treating waste gases.

In existing technologies, the DBD plasma technology has been used for SF₆ degradation experiments, analyzing the effects of factors such as different input voltages, different background gases, and different types and sizes of catalysts on the degradation efficiency of SF₆. When glass beads are used as a catalyst in experiments, the degradation efficiency is not high, and the degradation products contain a relatively high proportion of SO₂F₂ and less SO₂; when γ-Al₂O₃ is used as a catalyst, the products contain more SO₂, which inhibits the generation of substances such as SO₂F₂ and SOF₂. The above results indicate that different types of packing materials affect the distribution of degradation product contents, and metal oxides like γ-Al₂O₃ can improve the distribution of degradation product contents. Currently, for coaxial DBD plasma degradation of SF₆, the inner electrode consistently employs a single-tube structure, and the packing material needs to fill the entire DBD reactor, which affects economic costs. Numerous factors affect the degradation rate of SF₆, and different inner electrode structures also affect the degradation rate of SF₆, but such issues have not been extensively discussed, thus holding research value. Furthermore, given that the inner electrode structures used in DBD plasma degradation of SF₆ are currently overly simplistic, and different inner electrode structures likewise affect the degradation rate of SF₆, to change the filling form of the catalyst and reduce operating costs, a catalyst adsorption method can be adopted to solve this problem. Therefore, an apparatus and method for honeycomb ceramic-based plasma degradation of SF₆ are proposed to address the aforementioned issues.

### SUMMARY

In view of the deficiencies in the prior art, this disclosure provides an apparatus and method for honeycomb ceramic-based plasma degradation of SF₆, which possess advantages such as significantly improved degradation rate of SF₆ and environmental friendliness, and address the issues mentioned in the above background.

To achieve the aforementioned objectives of significantly improved degradation rate of SF₆ and environmental friendliness, this disclosure provides the following technical solution: an apparatus for honeycomb ceramic-based plasma degradation of SF₆, including a DBD reactor, where a gas supply unit is arranged on a left side of the DBD reactor, a power supply unit is arranged at a bottom of the DBD reactor, and a treatment unit is arranged on a right side of the DBD reactor;
the DBD reactor is connected to the gas supply unit via a gas pipe, electrically connected to the power supply unit, and connected to the treatment unit via a gas pipe;
the DBD reactor includes an outer electrode, inside which a detachable honeycomb ceramic-based inner electrode is clamped, where the detachable honeycomb ceramic-based inner electrode is composed of a honeycomb ceramic and an inner electrode tube, where the honeycomb ceramic is internally provided with an inner electrode tube hole and catalyst holes, the inner electrode tube is clamped inside the inner electrode tube hole, and the inner electrode tube hole is larger than the catalyst holes in size; and
a sealing connector is arranged on an outer surface of the outer electrode for connecting the gas pipes of the gas supply unit and the treatment unit in a sealing manner.

Preferably, the gas supply unit includes a gas proportioner, where a gas inlet of the gas proportioner is connected via gas pipes to an SF₆ gas supply cylinder and an argon gas supply cylinder, pressure reducing valves are arranged on outer surfaces of the gas pipes connecting the SF₆ gas supply cylinder and the argon gas supply cylinder to the gas proportioner, and an electromagnetic flowmeter and an electromagnetic valve are arranged on an outer surface of a gas pipe connecting the gas proportioner to the DBD reactor.

Preferably, the power supply unit includes a plasma power supply having one side electrically connected to a voltage regulator and the other side fixedly connected to an oscilloscope.

Preferably, the treatment unit includes an alkali liquor treatment tank, an exhaust gas pipe is fixedly connected to a top of the alkali liquor treatment tank, the alkali liquor treatment tank is filled with alkali liquor, and a gas pipe on the right side of the DBD reactor is inserted into the alkali liquor.

Preferably, the number of the inner electrode tube holes is one, the inner electrode tube hole has a diameter of 0.6 cm, the number of the catalyst holes is eight, the eight catalyst holes all have a diameter of 0.4 cm, the eight catalyst holes are uniformly distributed in a ring shape around an outer surface of the inner electrode tube hole, and the inner electrode tube has a length of 35 cm.

Preferably, a method for honeycomb ceramic-based plasma degradation of SF₆ includes the following specific degradation steps:
S1: clamping the inner electrode tube into the inner electrode tube hole, so that the honeycomb ceramic is positioned in a middle position of the inner electrode tube;
S2: preparing Cu(NO₃)₂ powder, adding water to the Cu(NO₃)₂ powder to obtain a mixture, and stirring the mixture evenly to obtain a Cu(NO₃)₂ aqueous solution without precipitation;
S3: completely immersing the detachable honeycomb ceramic-based inner electrode in the Cu(NO₃)₂ aqueous solution, followed by decomposition through evaporation on a water bath and high-temperature calcination to form a CuO catalyst, which is uniformly attached to the catalyst holes;
S4: sleeving the outer electrode onto an outer surface of the detachable honeycomb ceramic-based inner electrode, using flanges to connect both ends of the outer electrode to the gas proportioner and the alkali liquor treatment tank, and connecting the outer electrode to the plasma power supply using a high-voltage wire;
S5: connecting the SF₆ gas supply cylinder and the argon gas supply cylinder to the gas proportioner via gas pipes, and connecting the voltage regulator and the oscilloscope to the plasma power supply via electrical wires;
S6: opening the pressure reducing valves at the gas pipes of the SF₆ gas supply cylinder and the argon gas supply cylinder, controlling input openings of SF₆ and argon gases through the pressure reducing valves, and mixing them inside the gas proportioner based on a set ratio of the SF₆ and argon gases to form a uniform mixed gas;
S7: jointly controlling a flow rate of the mixed gas through the electromagnetic flowmeter and the electromagnetic valve, and conveying the mixed gas into the DBD reactor;
S8: starting the plasma power supply, where the mixed gas in the catalyst holes is broken down under an action of a high-voltage electric field to generate plasma, active species such as energetic electrons, ions, and free radicals in the plasma collide and react with SF₆ molecules, and the CuO catalyst synergistically exerts a catalytic effect in the plasma, promoting degradation of the SF₆ gas;
S9: after the degradation, first closing the pressure reducing valve at the SF₆ gas supply cylinder and maintaining stable operation of the DBD reactor; after 10 min, turning off the plasma power supply and continuing to introduce the argon gas, so that gases in the DBD reactor are discharged into the alkali liquor in the alkali liquor treatment tank for exhaust gas treatment, and discharged through the exhaust gas pipe; and
S10: finally, closing the pressure reducing valve at the argon gas supply cylinder.

Compared with the prior art, this disclosure provides an apparatus and method for honeycomb ceramic-based plasma degradation of SF₆, having the following beneficial effects:
1: the apparatus for the honeycomb ceramic-based plasma degradation of SF₆ breaks away from the conventional single-tube structured inner electrode by adopting a novel detachable honeycomb ceramic-based structure as the inner electrode of the reactor; its porous structure provides good channels for gas flow and distribution; the porous channels facilitate the adsorption of the catalyst and decomposition products, effectively promoting the degradation process; simultaneously, the honeycomb ceramic, serving as the inner electrode, employs a detachable design where the inner electrode tube is inserted into a slightly larger central hole of the honeycomb ceramic, facilitating apparatus installation, cleaning, and maintenance, thereby reducing operating costs; and
2: the method for the honeycomb ceramic-based plasma degradation of SF₆ utilizes Cu(NO₃)₂ powder as a precursor, which is converted into a CuO catalyst through evaporation on a water bath and high-temperature calcination, and attaches to the porous channels of the honeycomb ceramic; the CuO catalyst synergistically works with the plasma to promote dissociation of SF₆; concurrently, the surface of the catalyst can also serve as a site for reactions between active species and SF₆ molecules, accelerating the degradation reaction. Due to the presence of the CuO catalyst, the degradation products tend to generate SO₂ and effectively inhibit the generation of harmful gases such as SO₂F₂. The exhaust gas is treated through the alkali liquor treatment tank, where the alkali liquor can absorb and neutralize the majority of acidic gases, effectively preventing the post-reaction acidic gases from causing harm to human health and the environment.

### BRIEF DESCRIPTION OF THE DRAWINGS

FIG. 1 is a schematic structural diagram of an apparatus for honeycomb ceramic-based plasma degradation of SF₆ according to this disclosure;

FIG. 2 is a schematic diagram of a gas supply unit of the apparatus for the honeycomb ceramic-based plasma degradation of SF₆ according to this disclosure;

FIG. 3 is a schematic diagram of a DBD reactor of the apparatus for the honeycomb ceramic-based plasma degradation of SF₆ according to this disclosure;

FIG. 4 is a schematic diagram of a treatment unit of the apparatus for the honeycomb ceramic-based plasma degradation of SF₆ according to this disclosure;

FIG. 5 is a schematic diagram of a power supply unit of the apparatus for the honeycomb ceramic-based plasma degradation of SF₆ according to this disclosure;

FIG. 6 is a detailed schematic structural diagram of the DBD reactor of the apparatus for the honeycomb ceramic-based plasma degradation of SF₆ according to this disclosure; and

FIG. 7 is a schematic diagram of a honeycomb ceramic of the apparatus for the honeycomb ceramic-based plasma degradation of SF₆ according to this disclosure.

Reference signs used in the figures: 1—DBD reactor; 101—outer electrode; 102—detachable honeycomb ceramic-based inner electrode; 1021—inner electrode tube hole; 1022—catalyst hole; 1023—honeycomb ceramic; 1024—inner electrode tube; 103—sealing connector; 2—gas supply unit; 201—gas proportioner; 202—SF₆ gas supply cylinder; 203—argon gas supply cylinder; 204—pressure reducing valve; 205—electromagnetic flowmeter; 206—electromagnetic valve; 3—power supply unit; 301—plasma power supply; 302—voltage regulator; 303—oscilloscope; 4—treatment unit; 401—alkali liquor treatment tank; and 402—exhaust gas pipe.

### DETAILED DESCRIPTION OF THE EMBODIMENTS

The technical solutions in the embodiments of this disclosure will be clearly and completely described below with reference to the accompanying drawings in the embodiments of this disclosure. Apparently, the embodiments described below are merely some rather than all of the embodiments of this disclosure. All other embodiments obtained by a person of ordinary skill in the art based on the embodiments of this disclosure without making creative efforts shall fall within the protection scope of this disclosure.

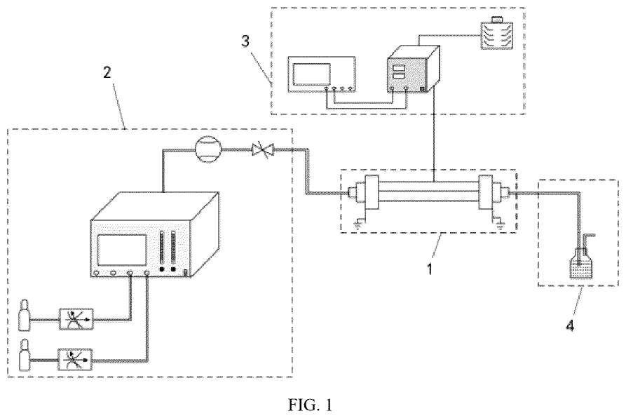

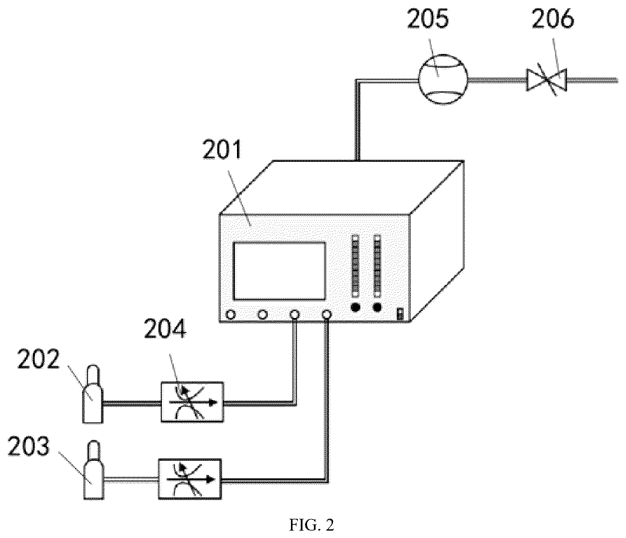

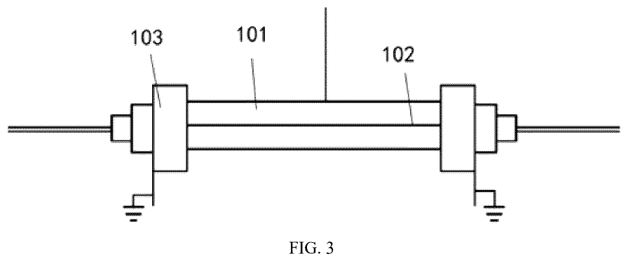

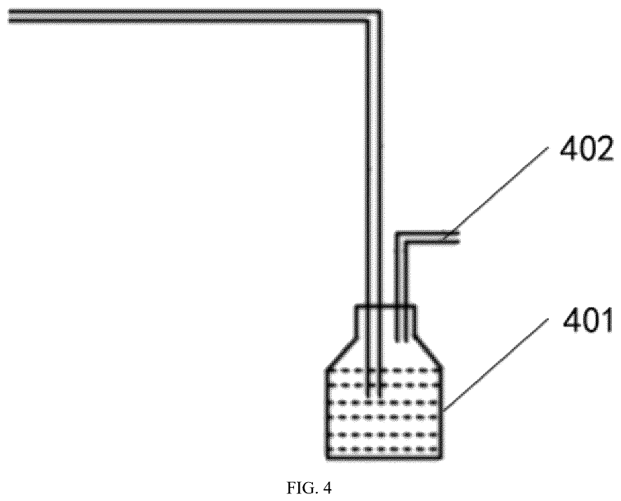

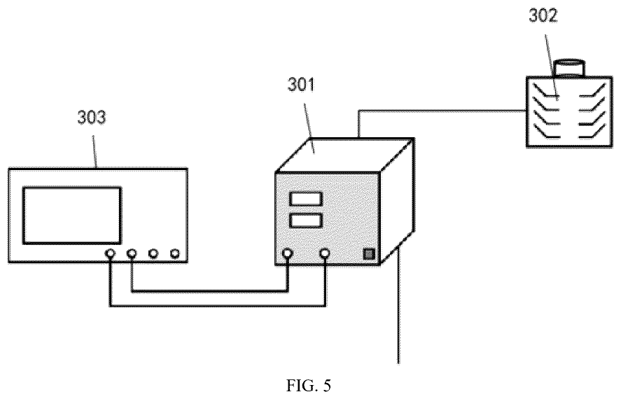

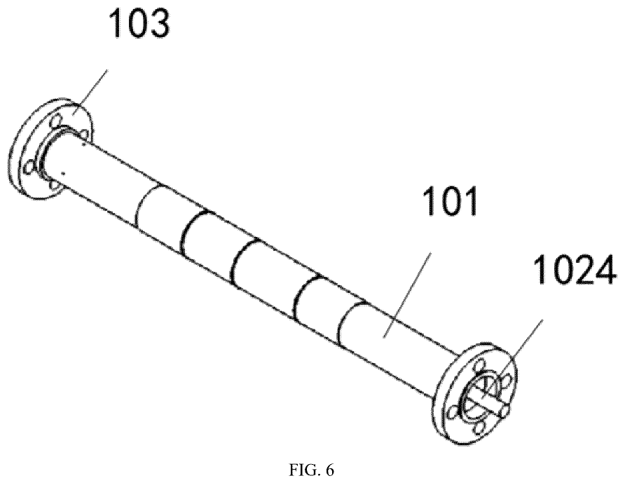

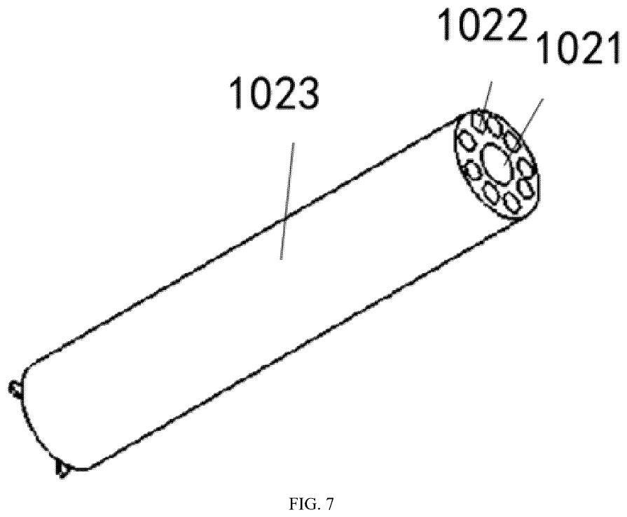

Example I: referring to FIGS. 1-7, an apparatus for honeycomb ceramic-based plasma degradation of SF₆ is provided, including a DBD reactor 1, where a gas supply unit 2 is arranged on a left side of the DBD reactor 1, a power supply unit 3 is arranged at a bottom of the DBD reactor 1, and a treatment unit 4 is arranged on a right side of the DBD reactor 1.

The DBD reactor 1 is connected to the gas supply unit 2 via a gas pipe, electrically connected to the power supply unit 3, and connected to the treatment unit 4 via a gas pipe; the DBD reactor 1 includes an outer electrode 101, inside which a detachable honeycomb ceramic-based inner electrode 102 is clamped, where the detachable honeycomb ceramic-based inner electrode 102 is composed of a honeycomb ceramic 1023 and an inner electrode tube 1024, where the honeycomb ceramic 1023 is internally provided with an inner electrode tube hole 1021 and catalyst holes 1022, the inner electrode tube 1024 is clamped inside the inner electrode tube hole 1021, and the inner electrode tube hole 1021 is larger than the catalyst holes 1022 in size. The structure of the honeycomb ceramic 1023 has a large specific surface area and porosity, which is conducive to uniform gas distribution and flow. Simultaneously, the porous structure can serve as a carrier for the catalyst. This structural design can effectively improve the degradation efficiency of SF₆. Moreover, the main component of the honeycomb ceramic is Al₂O₃, which can provide more active sites for the catalyst and accelerate the degradation reaction. Because the CuO catalyst has excellent catalytic activity, it can catalyze the decomposition of SF₆ molecules, reduce the reaction activation energy, and accelerate the degradation process. Furthermore, the degradation products tend to generate substances like SO₂ that are easier to treat.

Additionally, a sealing connector 103 is arranged on an outer surface of the outer electrode 101 for connecting the gas pipes of the gas supply unit 2 and the treatment unit 4 in a sealing manner. The number of the inner electrode tube holes 1021 is one, the inner electrode tube hole 1021 has a diameter of 0.6 cm, the number of the catalyst holes 1022 is eight, the eight catalyst holes 1022 all have a diameter of 0.4 cm, the eight catalyst holes 1022 are uniformly distributed in a ring shape around an outer surface of the inner electrode tube hole 1021, and the inner electrode tube 1024 has a length of 35 cm.

Furthermore, the gas supply unit 2 includes a gas proportioner 201, where a gas inlet of the gas proportioner 201 is connected via gas pipes to an SF₆ gas supply cylinder 202 and an argon gas supply cylinder 203, pressure reducing valves 204 are arranged on outer surfaces of the gas pipes connecting the SF₆ gas supply cylinder 202 and the argon gas supply cylinder 203 to the gas proportioner 201, and an electromagnetic flowmeter 205 and an electromagnetic valve 206 are arranged on an outer surface of a gas pipe connecting the gas proportioner 201 to the DBD reactor 1.

Moreover, the power supply unit 3 includes a plasma power supply 301 having one side electrically connected to a voltage regulator 302 and the other side fixedly connected to an oscilloscope 303.

In addition, the treatment unit 4 includes an alkali liquor treatment tank 401, an exhaust gas pipe 402 is fixedly connected to a top of the alkali liquor treatment tank 401, the alkali liquor treatment tank 401 is filled with alkali liquor, and a gas pipe on the right side of the DBD reactor 1 is inserted into the alkali liquor.

A method for honeycomb ceramic-based plasma degradation of SF₆ includes the following specific degradation steps:
S1: clamping the inner electrode tube 1024 into the inner electrode tube hole 1021, so that the honeycomb ceramic 1023 is positioned in a middle position of the inner electrode tube 1024;
S2: preparing 5.64 g of Cu(NO₃)₂ powder, adding 150 mL of water to the Cu(NO₃)₂ powder to obtain a mixture, and stirring the mixture evenly to obtain a Cu(NO₃)₂ aqueous solution without precipitation;
S3: completely immersing the detachable honeycomb ceramic-based inner electrode 102 in the Cu(NO₃)₂ aqueous solution, drying it through evaporation on a 100° C. water bath, then placing it in an oven at 150° C. for 8 h to completely evaporate the water, and finally, placing it in a tube furnace at 500° C. for high temperature calcination for 4 h, so that the CuO catalyst uniformly attaches to the catalyst holes 1022, where the CuO catalyst will uniformly attach to the porous channels of the honeycomb ceramic 1023, efficient degradation of SF₆ waste gas can be achieved through the synergistic effect of DBD plasma technology and the catalyst, and the degradation products tend to generate SO₂ which is easy to treat and, after treatment by the alkali liquor, can be directly discharged, reducing environmental pollution and providing an efficient and environmentally friendly waste gas treatment technology; the presence of CuO can significantly improve the degradation rate of SF₆ and provides certain product selectivity, making the SF₆ degradation products more inclined to generate substances easy to treat such as SO₂, and effectively inhibiting the generation of other hard-to-treat products such as SOF₂, SO₂F₂, and SOF₄;
S4: sleeving the outer electrode 101 onto an outer surface of the detachable honeycomb ceramic-based inner electrode 102, using flanges 104 to connect both ends of the outer electrode 101 to the gas proportioner 201 and the alkali liquor treatment tank 401, and connecting the outer electrode 101 to the plasma power supply 301 using a high-voltage wire;
S5: connecting the SF₆ gas supply cylinder 202 and the argon gas supply cylinder 203 to the gas proportioner 201 via gas pipes, and connecting the voltage regulator 302 and the oscilloscope 303 to the plasma power supply 301 via electrical wires;
S6: opening the pressure reducing valves 204 at the gas pipes of the SF₆ gas supply cylinder 202 and the argon gas supply cylinder 203, controlling input openings of SF₆ and argon gases through the pressure reducing valves 204, and fully mixing them inside the gas proportioner based on a ratio of the SF₆ and argon gases set by the gas proportioner 201, 2% SF₆ gas and 98% argon gas, to form a uniform mixed gas;
S7: jointly controlling a flow rate of the mixed gas through the electromagnetic flowmeter 205 and the electromagnetic valve 206, which is set to 300 mL/min, and conveying the mixed gas into the DBD reactor 1;
S8: starting the plasma power supply 301, with a discharge gap of 3 mm, where the mixed gas in the catalyst holes 1022 is broken down under an action of a high-voltage electric field to generate plasma, active species such as energetic electrons, ions, and free radicals in the plasma collide and react with SF₆ molecules, and the CuO catalyst synergistically exerts a catalytic effect in the plasma, promoting degradation of the SF₆ gas;
S9: after the degradation, first closing the pressure reducing valve 204 at the SF₆ gas supply cylinder 202 and maintaining stable operation of the DBD reactor 1; after 10 min, turning off the plasma power supply 301 and continuing to introduce the argon gas, so that gases in the DBD reactor 1 are discharged into the alkali liquor in the alkali liquor treatment tank 401 for exhaust gas treatment, and discharged through the exhaust gas pipe 402; exhaust gases, after treatment by the alkali liquor treatment tank 401, are discharged into the atmosphere, effectively avoiding impact on human health and the environment; and
S10: finally, closing the pressure reducing valve 204 at the argon gas supply cylinder 203.

TABLE 1
Experimental Data at a Ratio of Cu(NO₃)₂ Powder Mass
to Aqueous Solution Volume Being 5.64 g:150 mL

| | Cu(NO₃)₂:Aqueous Solution Volume = 5.64 g:150 mL | | | | |
|---|---|---|---|---|---|
| | | Product Selectivity (%) | | | |
| | Degradation | | | | Other |
| Power | Rate (%) | SO₂ | SO₂F₂ | SOF₄ | Substances |
| 60 | 69.7 | 48.3 | 10.1 | 6.2 | 5.1 |
| 70 | 71.0 | 51.1 | 9.3 | 7.6 | 3 |
| 80 | 73.4 | 53.3 | 8.9 | 6.4 | 4.8 |
| 90 | 75.8 | 54.0 | 9.1 | 6.6 | 6.1 |
| 100 | 77.6 | 55.6 | 9.2 | 7.1 | 5.7 |

In conclusion, the apparatus for the honeycomb ceramic-based plasma degradation of SF₆ has a detachable honeycomb ceramic-based inner electrode structure, whose porous channels facilitate uniform gas distribution and catalyst adsorption; CuO is uniformly attached to the porous channels of the honeycomb ceramic-based inner electrode through methods such as evaporation and drying on a water bath; and the CuO catalyst can reduce the activation energy required for the dissociation of SF₆, thereby accelerating the degradation reaction. Through the catalytic action of CuO and the enhancement effect of DBD plasma, the degradation rate of SF₆ can be significantly improved. Simultaneously, the presence of the CuO catalyst can reduce the generation of harmful products in the degradation process, effectively improving the distribution of degradation product contents. Furthermore, this apparatus does not generate secondary pollution during the degradation process of SF₆, meeting environmental protection requirements.

Moreover, the exhaust gas is treated by the alkali liquor treatment tank 401 before being discharged into the atmosphere, effectively avoiding impact on human health and the environment. This technical solution breaks away from the conventional single inner electrode structure and catalyst attachment method. It uses honeycomb ceramic as the inner electrode material, whose porous channels serve as attachment points for the CuO catalyst. Under the synergistic effect of plasma and the catalyst, efficient degradation of SF₆ is achieved. Concurrently, the main degradation product obtained with the CuO catalyst is SO₂, which is easy to treat and, when absorbed by alkali liquor solution, does not cause harm to human health or the environment.

Example II: referring to FIGS. 1-7, an apparatus for honeycomb ceramic-based plasma degradation of SF₆ is provided, including a DBD reactor 1, where a gas supply unit 2 is arranged on a left side of the DBD reactor 1, a power supply unit 3 is arranged at a bottom of the DBD reactor 1, and a treatment unit 4 is arranged on a right side of the DBD reactor 1.

The DBD reactor 1 is connected to the gas supply unit 2 via a gas pipe, electrically connected to the power supply unit 3, and connected to the treatment unit 4 via a gas pipe; the DBD reactor 1 includes an outer electrode 101, inside which a detachable honeycomb ceramic-based inner electrode 102 is clamped, where the detachable honeycomb ceramic-based inner electrode 102 is composed of a honeycomb ceramic 1023 and an inner electrode tube 1024, where the honeycomb ceramic 1023 is internally provided with an inner electrode tube hole 1021 and catalyst holes 1022, the inner electrode tube 1024 is clamped inside the inner electrode tube hole 1021, and the inner electrode tube hole 1021 is larger than the catalyst holes 1022 in size. The structure of the honeycomb ceramic 1023 has a large specific surface area and porosity, which is conducive to uniform gas distribution and flow. Simultaneously, the porous structure can serve as a carrier for the catalyst. This structural design can effectively improve the degradation efficiency of SF₆. Moreover, the main component of the honeycomb ceramic is Al₂O₃, which can provide more active sites for the catalyst and accelerate the degradation reaction. Because the CuO catalyst has excellent catalytic activity, it can catalyze the decomposition of SF₆ molecules, reduce the reaction activation energy, and accelerate the degradation process. Furthermore, the degradation products tend to generate substances like SO₂ that are easier to treat.

Additionally, a sealing connector 103 is arranged on an outer surface of the outer electrode 101 for connecting the gas pipes of the gas supply unit 2 and the treatment unit 4 in a sealing manner. The number of the inner electrode tube holes 1021 is one, the inner electrode tube hole 1021 has a diameter of 0.6 cm, the number of the catalyst holes 1022 is eight, the eight catalyst holes 1022 all have a diameter of 0.4 cm, the eight catalyst holes 1022 are uniformly distributed in a ring shape around an outer surface of the inner electrode tube hole 1021, and the inner electrode tube 1024 has a length of 35 cm.

Furthermore, the gas supply unit 2 includes a gas proportioner 201, where a gas inlet of the gas proportioner 201 is connected via gas pipes to an SF₆ gas supply cylinder 202 and an argon gas supply cylinder 203, pressure reducing valves 204 are arranged on outer surfaces of the gas pipes connecting the SF₆ gas supply cylinder 202 and the argon gas supply cylinder 203 to the gas proportioner 201, and an electromagnetic flowmeter 205 and an electromagnetic valve 206 are arranged on an outer surface of a gas pipe connecting the gas proportioner 201 to the DBD reactor 1.

Moreover, the power supply unit 3 includes a plasma power supply 301 having one side electrically connected to a voltage regulator 302 and the other side fixedly connected to an oscilloscope 303.

In addition, the treatment unit 4 includes an alkali liquor treatment tank 401, an exhaust gas pipe 402 is fixedly connected to a top of the alkali liquor treatment tank 401, the alkali liquor treatment tank 401 is filled with alkali liquor, and a gas pipe on the right side of the DBD reactor 1 is inserted into the alkali liquor.

A method for honeycomb ceramic-based plasma degradation of SF₆ includes the following specific degradation steps:
S1: clamping the inner electrode tube 1024 into the inner electrode tube hole 1021, so that the honeycomb ceramic 1023 is positioned in a middle position of the inner electrode tube 1024;
S2: preparing 8.46 g of Cu(NO₃)₂ powder, adding 150 ml of water to the Cu(NO₃)₂ powder to obtain a mixture, and stirring the mixture evenly to obtain a Cu(NO₃)₂ aqueous solution without precipitation;
S3: completely immersing the detachable honeycomb ceramic-based inner electrode 102 in the Cu(NO₃)₂ aqueous solution, drying it through evaporation on a 100° C. water bath, then placing it in an oven at 150° C. for 8 h to completely evaporate the water, and finally, placing it in a tube furnace at 500° C. for high temperature calcination for 4 h, so that the CuO catalyst uniformly attaches to the catalyst holes 1022, where the CuO catalyst will uniformly attach to the porous channels of the honeycomb ceramic 1023, efficient degradation of SF₆ waste gas can be achieved through the synergistic effect of DBD plasma technology and the catalyst, and the degradation products tend to generate SO₂ which is easy to treat and, after treatment by the alkali liquor, can be directly discharged, reducing environmental pollution and providing an efficient and environmentally friendly waste gas treatment technology; the presence of CuO can significantly improve the degradation rate of SF₆ and provides certain product selectivity, making the SF₆ degradation products more inclined to generate substances easy to treat such as SO₂, and effectively inhibiting the generation of other hard-to-treat products such as SOF₂, SO₂F₂, and SOF₄;
S4: sleeving the outer electrode 101 onto an outer surface of the detachable honeycomb ceramic-based inner electrode 102, using flanges 104 to connect both ends of the outer electrode 101 to the gas proportioner 201 and the alkali liquor treatment tank 401, and connecting the outer electrode 101 to the plasma power supply 301 using a high-voltage wire;
S5: connecting the SF₆ gas supply cylinder 202 and the argon gas supply cylinder 203 to the gas proportioner 201 via gas pipes, and connecting the voltage regulator 302 and the oscilloscope 303 to the plasma power supply 301 via electrical wires;
S6: opening the pressure reducing valves 204 at the gas pipes of the SF₆ gas supply cylinder 202 and the argon gas supply cylinder 203, controlling input openings of SF₆ and argon gases through the pressure reducing valves 204, and fully mixing them inside the gas proportioner based on a ratio of the SF₆ and argon gases set by the gas proportioner 201, 2% SF₆ gas and 98% argon gas, to form a uniform mixed gas;
S7: jointly controlling a flow rate of the mixed gas through the electromagnetic flowmeter 205 and the electromagnetic valve 206, which is set to 300 mL/min, and conveying the mixed gas into the DBD reactor 1;
S8: starting the plasma power supply 301, with a discharge gap of 3 mm, where the mixed gas in the catalyst holes 1022 is broken down under an action of a high-voltage electric field to generate plasma, active species such as energetic electrons, ions, and free radicals in the plasma collide and react with SF₆ molecules, and the CuO catalyst synergistically exerts a catalytic effect in the plasma, promoting degradation of the SF₆ gas;
S9: after the degradation, first closing the pressure reducing valve 204 at the SF₆ gas supply cylinder 202 and maintaining stable operation of the DBD reactor 1; after 10 min, turning off the plasma power supply 301 and continuing to introduce the argon gas, so that gases in the DBD reactor 1 are discharged into the alkali liquor in the alkali liquor treatment tank 401 for exhaust gas treatment, and discharged through the exhaust gas pipe 402; exhaust gases, after treatment by the alkali liquor treatment tank 401, are discharged into the atmosphere, effectively avoiding impact on human health and the environment; and
S10: finally, closing the pressure reducing valve 204 at the argon gas supply cylinder 203.

TABLE 2
Experimental Data at a Ratio of Cu(NO₃)₂ Powder Mass
to Aqueous Solution Volume Being 8.46 g:150 mL

| | Cu(NO₃)₂:Aqueous Solution Volume = 8.46 g:150 mL | | | | |
|---|---|---|---|---|---|
| | | Product Selectivity (%) | | | |
| | Degradation | | | | Other |
| Power | Rate (%) | SO₂ | SO₂F₂ | SOF₄ | Substances |
| 60 | 87.4 | 63.7 | 7.5 | 8.9 | 7.3 |
| 70 | 90.8 | 69.1 | 6.8 | 7.4 | 7.5 |
| 80 | 93.6 | 74.7 | 6.4 | 6.9 | 5.6 |
| 90 | 95.7 | 79.6 | 5.8 | 5.1 | 5.2 |
| 100 | 97.0 | 81.5 | 5.3 | 5.0 | 5.2 |

In conclusion, the apparatus for the honeycomb ceramic-based plasma degradation of SF₆ has a detachable honeycomb ceramic-based inner electrode structure, whose porous channels facilitate uniform gas distribution and catalyst adsorption; CuO is uniformly attached to the porous channels of the honeycomb ceramic-based inner electrode through methods such as evaporation and drying on a water bath; and the CuO catalyst can reduce the activation energy required for the dissociation of SF₆, thereby accelerating the degradation reaction. Through the catalytic action of CuO and the enhancement effect of DBD plasma, the degradation rate of SF₆ can be significantly improved. Simultaneously, the presence of the CuO catalyst can reduce the generation of harmful products in the degradation process of SF₆, effectively improving the distribution of degradation product contents. Furthermore, this apparatus does not generate secondary pollution during the degradation process of SF₆, meeting environmental protection requirements.

Moreover, the exhaust gas is treated by the alkali liquor treatment tank 401 before being discharged into the atmosphere, effectively avoiding impact on human health and the environment. This technical solution breaks away from the conventional single inner electrode structure and catalyst attachment method. It uses honeycomb ceramic as the inner electrode material, whose porous channels serve as attachment points for the CuO catalyst. Under the synergistic effect of plasma and the catalyst, efficient degradation of SF₆ is achieved. Concurrently, the main degradation product obtained with the CuO catalyst is SO₂, which is easy to treat and, when absorbed by alkali liquor solution, does not cause harm to human health or the environment.

Example III: referring to FIGS. 1-7, an apparatus for honeycomb ceramic-based plasma degradation of SF₆ is provided, including a DBD reactor 1, where a gas supply unit 2 is arranged on a left side of the DBD reactor 1, a power supply unit 3 is arranged at a bottom of the DBD reactor 1, and a treatment unit 4 is arranged on a right side of the DBD reactor 1.

The DBD reactor 1 is connected to the gas supply unit 2 via a gas pipe, electrically connected to the power supply unit 3, and connected to the treatment unit 4 via a gas pipe; the DBD reactor 1 includes an outer electrode 101, inside which a detachable honeycomb ceramic-based inner electrode 102 is clamped, where the detachable honeycomb ceramic-based inner electrode 102 is composed of a honeycomb ceramic 1023 and an inner electrode tube 1024, where the honeycomb ceramic 1023 is internally provided with an inner electrode tube hole 1021 and catalyst holes 1022, the inner electrode tube 1024 is clamped inside the inner electrode tube hole 1021, and the inner electrode tube hole 1021 is larger than the catalyst holes 1022 in size. The structure of the honeycomb ceramic 1023 has a large specific surface area and porosity, which is conducive to uniform gas distribution and flow. Simultaneously, the porous structure can serve as a carrier for the catalyst. This structural design can effectively improve the degradation efficiency of SF₆. Moreover, the main component of the honeycomb ceramic is Al₂O₃, which can provide more active sites for the catalyst and accelerate the degradation reaction. Because the CuO catalyst has excellent catalytic activity, it can catalyze the decomposition of SF₆ molecules, reduce the reaction activation energy, and accelerate the degradation process. Furthermore, the degradation products tend to generate substances like SO₂ that are easier to treat.

Additionally, a sealing connector 103 is arranged on an outer surface of the outer electrode 101 for connecting the gas pipes of the gas supply unit 2 and the treatment unit 4 in a sealing manner. The number of the inner electrode tube holes 1021 is one, the inner electrode tube hole 1021 has a diameter of 0.6 cm, the number of the catalyst holes 1022 is eight, the eight catalyst holes 1022 all have a diameter of 0.4 cm, the eight catalyst holes 1022 are uniformly distributed in a ring shape around an outer surface of the inner electrode tube hole 1021, and the inner electrode tube 1024 has a length of 35 cm.

Furthermore, the gas supply unit 2 includes a gas proportioner 201, where a gas inlet of the gas proportioner 201 is connected via gas pipes to an SF₆ gas supply cylinder 202 and an argon gas supply cylinder 203, pressure reducing valves 204 are arranged on outer surfaces of the gas pipes connecting the SF₆ gas supply cylinder 202 and the argon gas supply cylinder 203 to the gas proportioner 201, and an electromagnetic flowmeter 205 and an electromagnetic valve 206 are arranged on an outer surface of a gas pipe connecting the gas proportioner 201 to the DBD reactor 1.

Moreover, the power supply unit 3 includes a plasma power supply 301 having one side electrically connected to a voltage regulator 302 and the other side fixedly connected to an oscilloscope 303.

In addition, the treatment unit 4 includes an alkali liquor treatment tank 401, an exhaust gas pipe 402 is fixedly connected to a top of the alkali liquor treatment tank 401, the alkali liquor treatment tank 401 is filled with alkali liquor, and a gas pipe on the right side of the DBD reactor 1 is inserted into the alkali liquor.

A method for honeycomb ceramic-based plasma degradation of SF₆ includes the following specific degradation steps:
S1: clamping the inner electrode tube 1024 into the inner electrode tube hole 1021, so that the honeycomb ceramic 1023 is positioned in a middle position of the inner electrode tube 1024;
S2: preparing 11.28 g of Cu(NO₃)₂ powder, adding 150 ml of water to the Cu(NO₃)₂ powder to obtain a mixture, and stirring the mixture evenly to obtain a Cu(NO₃)₂ aqueous solution without precipitation;
S3: completely immersing the detachable honeycomb ceramic-based inner electrode 102 in the Cu(NO₃)₂ aqueous solution, drying it through evaporation on a 100° C. water bath, then placing it in an oven at 150° C. for 8 h to completely evaporate the water, and finally, placing it in a tube furnace at 500° C. for high temperature calcination for 4 h, so that the CuO catalyst uniformly attaches to the catalyst holes 1022, where the CuO catalyst will uniformly attach to the porous channels of the honeycomb ceramic 1023, efficient degradation of SF₆ waste gas can be achieved through the synergistic effect of DBD plasma technology and the catalyst, and the degradation products tend to generate SO₂ which is easy to treat and, after treatment by the alkali liquor, can be directly discharged, reducing environmental pollution and providing an efficient and environmentally friendly waste gas treatment technology; the presence of CuO can significantly improve the degradation rate of SF₆ and provides certain product selectivity, making the SF₆ degradation products more inclined to generate substances easy to treat such as SO₂, and effectively inhibiting the generation of other hard-to-treat products such as SOF₂, SO₂F₂, and SOF₄;
S4: sleeving the outer electrode 101 onto an outer surface of the detachable honeycomb ceramic-based inner electrode 102, using flanges 104 to connect both ends of the outer electrode 101 to the gas proportioner 201 and the alkali liquor treatment tank 401, and connecting the outer electrode 101 to the plasma power supply 301 using a high-voltage wire;
S5: connecting the SF₆ gas supply cylinder 202 and the argon gas supply cylinder 203 to the gas proportioner 201 via gas pipes, and connecting the voltage regulator 302 and the oscilloscope 303 to the plasma power supply 301 via electrical wires;
S6: opening the pressure reducing valves 204 at the gas pipes of the SF₆ gas supply cylinder 202 and the argon gas supply cylinder 203, controlling input openings of SF₆ and argon gases through the pressure reducing valves 204, and fully mixing them inside the gas proportioner based on a ratio of the SF₆ and argon gases set by the gas proportioner 201, 2% SF₆ gas and 98% argon gas, to form a uniform mixed gas;
S7: jointly controlling a flow rate of the mixed gas through the electromagnetic flowmeter 205 and the electromagnetic valve 206, which is set to 300 mL/min, and conveying the mixed gas into the DBD reactor 1;
S8: starting the plasma power supply 301, with a discharge gap of 3 mm, where the mixed gas in the catalyst holes 1022 is broken down under an action of a high-voltage electric field to generate plasma, active species such as energetic electrons, ions, and free radicals in the plasma collide and react with SF₆ molecules, and the CuO catalyst synergistically exerts a catalytic effect in the plasma, promoting degradation of the SF₆ gas;
S9: after the degradation, first closing the pressure reducing valve 204 at the SF₆ gas supply cylinder 202 and maintaining stable operation of the DBD reactor 1; after 10 min, turning off the plasma power supply 301 and continuing to introduce the argon gas, so that gases in the DBD reactor 1 are discharged into the alkali liquor in the alkali liquor treatment tank 401 for exhaust gas treatment, and discharged through the exhaust gas pipe 402; exhaust gases, after treatment by the alkali liquor treatment tank 401, are discharged into the atmosphere, effectively avoiding impact on human health and the environment; and
S10: finally, closing the pressure reducing valve 204 at the argon gas supply cylinder 203.

TABLE 3
Experimental Data at a Ratio of Cu(NO₃)₂ Powder Mass
to Aqueous Solution Volume Being 11.28 g:150 mL

| | Cu(NO₃)₂:Aqueous Solution Volume = 11.28 g:150 mL | | | | |
|---|---|---|---|---|---|
| | | Product Selectivity (%) | | | |
| | Degradation | | | | Other |
| Power | Rate (%) | SO₂ | SO₂F₂ | SOF₄ | Substances |
| 60 | 65.7 | 49.1 | 6.7 | 4.8 | 5.1 |
| 70 | 69.4 | 51.4 | 6.5 | 5.2 | 6.3 |
| 80 | 72.8 | 54.7 | 6.4 | 5.1 | 6.6 |
| 90 | 74.6 | 55.2 | 6.8 | 5.5 | 7.1 |
| 100 | 78.9 | 58.8 | 7.0 | 5.8 | 7.3 |

In conclusion, the apparatus for the honeycomb ceramic-based plasma degradation of SF₆ has a detachable honeycomb ceramic-based inner electrode structure, whose porous channels facilitate uniform gas distribution and catalyst adsorption; CuO is uniformly attached to the porous channels of the honeycomb ceramic-based inner electrode through methods such as evaporation and drying on a water bath; and the CuO catalyst can reduce the activation energy required for the dissociation of SF₆, thereby accelerating the degradation reaction. Through the catalytic action of CuO and the enhancement effect of DBD plasma, the degradation rate of SF₆ can be significantly improved. Simultaneously, the presence of the CuO catalyst can reduce the generation of harmful products in the degradation process, effectively improving the distribution of degradation product contents. Furthermore, this apparatus does not generate secondary pollution during the degradation process of SF₆, meeting environmental protection requirements.

Moreover, the exhaust gas is treated by the alkali liquor treatment tank 401 before being discharged into the atmosphere, effectively avoiding impact on human health and the environment. This technical solution breaks away from the conventional single inner electrode structure and catalyst attachment method. It uses honeycomb ceramic as the inner electrode material, whose porous channels serve as attachment points for the CuO catalyst. Under the synergistic effect of plasma and the catalyst, efficient degradation of SF₆ is achieved. Concurrently, the main degradation product obtained with the CuO catalyst is SO₂, which is easy to treat and, when absorbed by alkali liquor solution, does not cause harm to human health or the environment.

Comparative experiments were conducted using different masses of Cu(NO₃)₂ powder while maintaining a constant aqueous solution volume of 150 mL. Multiple sets of experimental comparisons revealed that: when the mass of Cu(NO₃)₂ powder was 5.64 g, the concentration of Cu(NO₃)₂ powder in the solution was too low, resulting in incomplete attachment of CuO to the porous channels of the honeycomb ceramic after subsequent evaporation on a water bath and high-temperature calcination, leading to a maximum degradation rate of SF₆ being only 77.6%; when the mass of Cu(NO₃)₂ powder was 11.28 g, the concentration of the prepared aqueous solution might be too high, causing partial crystallization during the evaporation on a water bath, which affected the experimental results, with a maximum degradation rate of 78.9%; based on the above, 8.46 g of Cu(NO₃)₂ powder was selected and mixed with 150 ml of water to prepare the Cu(NO₃)₂ aqueous solution. At a power input of 100 W, the maximum degradation rate reached 97.0%, with SO₂ accounting for the highest proportion among the degradation products, and most acidic gases could be directly absorbed by the alkali liquor.

It should be further noted that the terms “include”, “comprise” or any other variants thereof are intended to encompass non-exclusive inclusion, so that a process, method, article, or device that involves a series of elements includes not only those elements, but also other elements not explicitly listed, or elements that are inherent to such a process, method, article, or device. An element defined by “including a . . . ” does not, without more constraints, preclude the existence of additional identical elements in the process, method, article, or device that includes the element.

Although the embodiments of this disclosure have been shown and described, it will be appreciated by a person of ordinary skill in the art that various changes, modifications, substitutions, and variations can be made to these embodiments without departing from the principle and spirit of this disclosure, and the scope of this disclosure is defined by the appended claims and their equivalents.

What is claimed is:

1. An apparatus for honeycomb ceramic-based plasma degradation of SF₆, comprising a DBD reactor (1), wherein a gas supply unit (2) is arranged on a left side of the DBD reactor (1), a power supply unit (3) is arranged at a bottom of the DBD reactor (1), and a treatment unit (4) is arranged on a right side of the DBD reactor (1);
the DBD reactor (1) is connected to the gas supply unit (2) via a gas pipe, electrically connected to the power supply unit (3), and connected to the treatment unit (4) via a gas pipe;
the DBD reactor (1) comprises an outer electrode (101), inside which a detachable honeycomb ceramic-based inner electrode (102) is clamped, wherein the detachable honeycomb ceramic-based inner electrode (102) is composed of a honeycomb ceramic (1023) and an inner electrode tube (1024), wherein the honeycomb ceramic (1023) is internally provided with an inner electrode tube hole (1021) and catalyst holes (1022), the inner electrode tube (1024) is clamped inside the inner electrode tube hole (1021), and the inner electrode tube hole (1021) is larger than the catalyst holes (1022) in size;
a sealing connector (103) is arranged on an outer surface of the outer electrode (101) for connecting the gas pipes of the gas supply unit (2) and the treatment unit (4) in a sealing manner; and
the catalyst holes (1022) are uniformly distributed in a ring shape around an outer surface of the inner electrode tube hole (1021).

2. The apparatus for the honeycomb ceramic-based plasma degradation of SF₆ of claim 1, wherein the gas supply unit (2) comprises a gas proportioner (201), wherein a gas inlet of the gas proportioner (201) is connected via gas pipes to an SF₆ gas supply cylinder (202) and an argon gas supply cylinder (203), pressure reducing valves (204) are arranged on outer surfaces of the gas pipes connecting the SF₆ gas supply cylinder (202) and the argon gas supply cylinder (203) to the gas proportioner (201), and an electromagnetic flowmeter (205) and an electromagnetic valve (206) are arranged on an outer surface of a gas pipe connecting the gas proportioner (201) to the DBD reactor (1).

3. The apparatus for the honeycomb ceramic-based plasma degradation of SF₆ of claim 1, wherein the power supply unit (3) comprises a plasma power supply (301) having one side electrically connected to a voltage regulator (302) and the other side fixedly connected to an oscilloscope (303).

4. The apparatus for the honeycomb ceramic-based plasma degradation of SF₆ of claim 1, wherein the treatment unit (4) comprises an alkali liquor treatment tank (401), an exhaust gas pipe (402) is fixedly connected to a top of the alkali liquor treatment tank (401), the alkali liquor treatment tank (401) is filled with alkali liquor, and a gas pipe on the right side of the DBD reactor (1) is inserted into the alkali liquor.

5. The apparatus for the honeycomb ceramic-based plasma degradation of SF₆ of claim 1, wherein the sealing connector (103) is a flange.

6. A method for honeycomb ceramic-based plasma degradation of SF₆ using the apparatus of claim 1, comprising the following specific degradation steps:
S1: clamping the inner electrode tube (1024) into the inner electrode tube hole (1021), so that the honeycomb ceramic (1023) is positioned in a middle position of the inner electrode tube (1024);
S2: preparing Cu(NO₃)₂ powder, adding water to the Cu(NO₃)₂ powder to obtain a mixture, and stirring the mixture evenly to obtain a Cu(NO₃)₂ aqueous solution without precipitation;
S3: completely immersing the detachable honeycomb ceramic-based inner electrode (102) in the Cu(NO₃)₂ aqueous solution, followed by decomposition through evaporation on a water bath and high-temperature calcination to form a CuO catalyst, which is uniformly attached to the catalyst holes (1022);
S4: sleeving the outer electrode (101) onto an outer surface of the detachable honeycomb ceramic-based inner electrode (102), using flanges (104) to connect both ends of the outer electrode (101) to the gas proportioner (201) and the alkali liquor treatment tank (401), and connecting the outer electrode (101) to the plasma power supply (301) using a high-voltage wire;
S5: connecting the SF₆ gas supply cylinder (202) and the argon gas supply cylinder (203) to the gas proportioner (201) via gas pipes, and connecting the voltage regulator (302) and the oscilloscope (303) to the plasma power supply (301) via electrical wires;
S6: opening the pressure reducing valves (204) at the gas pipes of the SF₆ gas supply cylinder (202) and the argon gas supply cylinder (203), controlling input openings of SF₆ and argon gases through the pressure reducing valves (204), and mixing them inside the gas proportioner (201) based on a set ratio of the SF₆ and argon gases to form a uniform mixed gas;
S7: jointly controlling a flow rate of the mixed gas through the electromagnetic flowmeter (205) and the electromagnetic valve (206), and conveying the mixed gas into the DBD reactor (1);
S8: starting the plasma power supply (301), where the mixed gas in the catalyst holes (1022) is broken down under an action of a high-voltage electric field to generate plasma, active species such as energetic electrons, ions, and free radicals in the plasma collide and react with SF₆ molecules, and the CuO catalyst synergistically exerts a catalytic effect in the plasma, promoting degradation of the SF₆ gas;
S9: after the degradation, first closing the pressure reducing valve (204) at the SF₆ gas supply cylinder (202) and maintaining stable operation of the DBD reactor (1); after 10 min, turning off the plasma power supply (301) and continuing to introduce the argon gas, so that gases in the DBD reactor (1) are discharged into the alkali liquor in the alkali liquor treatment tank (401) for exhaust gas treatment, and discharged through the exhaust gas pipe (402); and
S10: finally, closing the pressure reducing valve (204) at the argon gas supply cylinder (203).
